(19) United States
(12) Patent Application Publication
(10) Pub. No.: US 2025/0242359 A1
(43) Pub. Date: Jul. 31, 2025

(54) SOLID BOWL SCREW CENTRIFUGE

(71) Applicant: GEA WESTFALIA SEPARATOR GROUP GMBH, Oelde (DE)

(72) Inventor: Poul-Erik AAGAARD, Sporup (DK)

(21) Appl. No.: 18/854,114

(22) PCT Filed: Mar. 16, 2023
(86) PCT No.: PCT/EP2023/056730

§ 371 Date: Oct. 4, 2024

(30) Foreign Application Priority Data
Apr. 6, 2022 (DE) 20 2022 101 838.3

(51) Int. Cl. B04B 1/20

(52) U.S. Cl. CPC B04B 1/20; B04B 2001/2033; B04B 2001/2083; B04B 2001/2091

(57) ABSTRACT

A solid bowl screw centrifuge has a feed pipe with a diameter initially increasing in the axial direction towards in the direction of flow to form a first feed pipe section in which a centrifugal pre-separation of a part of the solid phase from the suspension occurs. A first portion with a higher solids content compared to the suspension is introduced by a first outlet into the centrifugal chamber in the radial direction. A second feed pipe section adjoins the first feed pipe section axially in the direction of flow, through which the remaining second portion of the suspension that is not discharged through the first outlet and has a lower solids content compared with the suspension is guided further axially through the feed pipe. The remaining second portion of the suspension is introduced into the centrifugal chamber in the radial direction via a second outlet.

### BACKGROUND AND SUMMARY OF THE INVENTION

Exemplary embodiments of the invention relate to a solid bowl screw centrifuge.

A solid phase can be separated from a suspension using a solid bowl screw centrifuge—also known as a decanter in technical jargon. Optionally, the suspension clarified from solids in this way can be separated into different liquid phases in a design with two liquid outlets. Solid bowl screw centrifuges are very suitable for processing comparatively high concentrations of solids in the feed stream, are comparatively robust, achieve very good separation results, and dry the solids well.

Known solid bowl screw centrifuges with a non-rotatable or non-rotating frame during operation have a rotating or rotating rotor, which in turn has a bowl and a screw that can rotate at a differential speed to the bowl. To discharge the solids, essentially radially aligned solids discharge openings are provided in a conically shaped section of the bowl.

Some suspensions or products that are to be separated or clarified by centrifugal separation—for example those to which a flocculant has been added—are shear-sensitive and require very gentle acceleration and handling in a solid bowl screw centrifuge in order to achieve the desired sedimentation and clear separation.

In many cases, the suspension to be clarified or separated—also known as the product—is fed into the solid bowl screw centrifuge via a stationary feed pipe, which guides the suspension axially/laminar into a distribution chamber, where it is then accelerated and diverted to enter the separation chamber of the solid bowl screw centrifuge radially.

In the distribution chamber, the suspension is subject to high acceleration in a very turbulent environment. This can lead to high shear forces in the suspension and reduce efficient separation, particularly in the case of polymer-assisted flocculation of the suspension, as the bond between the flocculant and the solid to be separated is dissolved again.

It is known from DE 28 22 533 that the inflowing product is fed from a stationary feed pipe into a rotating distribution chamber, the outlets of which, however, do not reach into the area of the separation chamber of the solid bowl screw centrifuge in which the liquid phase separated from the suspension collects, which is also called a “pond” or “pool” in technical terminology (see DE 28 22 533, FIG. 1a). A feed line for a flocculant can be arranged in the stationary feed pipe.

A distribution chamber for solid bowl screw centrifuges is known from EP 0 099 267, which is provided with feed sleeves whose outlet opening ends in the “pool”, i.e., extends into the area of the separation chamber of the solid bowl screw centrifuge in which the liquid phase separated from the suspension collects (see EP 0 099 267, FIG. 5). The feed pipe does not rotate here.

A distribution chamber for solid bowl screw centrifuges is known from EP 1 225 981, which is provided with feed sleeves whose outlet openings end in the “pool”, i.e., extend into the area of the separation chamber of the solid bowl screw centrifuge in which the liquid phase separated from the suspension collects (see EP 1 225 981, FIG. 1). The feed pipe rotates at screw speed.

A disadvantage of the prior art solutions is that the suspension is not always optimally introduced into the distribution chamber and finally into the separation chamber, which entails the risk of turbulent flow in the distribution chamber and the occurrence of shear forces in the suspension cannot be completely ruled out, so that the micro- or macroflocs of the solid phase created by the addition of the flocculant are destroyed by the shear forces, resulting in unsatisfactory solids separation.

In this respect, the prior art is to be optimized with regard to the clarification properties, for example in the event that a suspension Su of solids to which a flocculant has been added is to be clarified.

Exemplary embodiments of the invention are directed to a solution to this problem.

Accordingly, a solid bowl screw centrifuge is created, designed for the clarification of an incoming suspension Su in a centrifugal field from a solid phase Fe, provided with a housing and a rotor rotatably mounted in the housing, wherein the rotor comprises at least the following:

having a housing and a rotor rotatably mounted in the housing, wherein the rotor comprises at least the following:
a rotatable bowl with an axis of rotation, wherein the bowl has a cylindrical section and a conical section,
a feed pipe projecting into the bowl and arranged concentrically to the axis of rotation D, through which the suspension Su to be processed can be fed into a centrifugal chamber of the bowl,
at least one liquid outlet arranged in the cylindrical section of the bowl, and
at least one solids discharge arranged in the conical section of the bowl,
a screw arranged in the bowl, which can rotate relative to the rotatable bowl at a differential speed, wherein the bowl and the screw together form the rotor,
wherein the feed pipe rotates during operation of the solid bowl screw centrifuge, and
wherein the inner diameter of the feed pipe initially increases in the axial direction towards the conical section of the screw in the direction of flow such that a first feed pipe section is formed in which centrifugal pre-separation of a part of the solid phase Fe from the suspension takes place, wherein first means are present, by means of which a first portion Su′ of the suspension with a higher solids content compared with the suspension Su can be introduced into the centrifugal chamber in the radial direction, and
wherein the first feed pipe section is further adjoined axially in the direction of flow by a second feed pipe section, through which the remaining second portion Su″ of the suspension Su with a lower solids content compared with the suspension Su, which is not discharged by the first means, is guided axially further through the feed pipe close to the axis of rotation of the feed pipe, wherein second means are provided, through which the remaining second portion Su″ of the suspension can be introduced in the radial direction into the centrifugal chamber.

Due to the centrifugal acceleration near the axis of rotation, pre-separation of part of the solid phase can already take place in the rotating feed pipe in the first feed pipe section with a radially widening diameter under a relatively low effect of shear forces due to the still relatively small radius compared to the average radius of the centrifugal chamber and the shear forces occurring there. Due to the minimal effect of shear forces in the suspension, an added flocculant can act as intended, so that micro- or macroflocs of the solid phase created by the flocculant are not destroyed by shear forces, resulting in very good solids separation. Through the first means, a corresponding first portion Su′ of the suspension with a higher solids content compared to the supplied suspension Su is then introduced into the centrifugal chamber in a radial direction. At another point of the rotating feed pipe, the remaining second portion Su″ of the suspension is then introduced into the centrifugal chamber in a radial direction by the second means.

It is preferably provided that the maximum inner diameter of the feed pipe in the first feed pipe section is larger than the inner diameter of the second feed pipe section.

In a particularly preferred embodiment variant of the invention, it is provided that the inner diameter of the feed pipe in the first feed pipe section increases continuously over its axial length. In this way, a pre-separation of the solid phase with particularly minimal effect of shear forces on the solid phase in the feed pipe can be achieved by simple design means.

In a further particularly preferred embodiment variant of the invention, it is provided that the first feed pipe section forms an inner cone. In this way, a continuous expansion of the inner diameter of the feed pipe can be achieved by simple design means that are just as easy to implement in terms of production technology.

Alternatively, in a further preferred embodiment variant of the invention, it can also be provided that the first feed pipe section has the shape of an internal paraboloid. In this way, a continuous expansion of the inner diameter of the feed pipe can also be achieved using simple design means that are just as easy to implement in terms of production technology.

In a further particularly preferred embodiment variant of the invention, it can be provided that the first means by which a first portion Su′ of the suspension Su can be introduced into the centrifugal chamber in the radial direction are designed as at least one first feed sleeve extending radially from the first feed pipe section into the centrifugal chamber. This enables a gentle introduction of the first portion Su′ of the suspension Su into the centrifugal chamber by means of structurally simple means, which are just as easy to implement in terms of production technology.

Furthermore, in a further particularly preferred embodiment variant of the invention, it is provided that the respective first feed sleeve forms an outlet nozzle through which the first portion Su′ of the suspension Su is directed into the centrifugal chamber on a first radius R1. The first radius R1, at which the respective first feed sleeve opens into the centrifugal chamber, is selected such that the discharge of the first portion Su′ of the suspension Su into the corresponding solids-bearing layer in the centrifugal chamber is advantageously enabled without turbulence occurring during the introduction, which interferes with other phases. The first radius can preferably be larger than the mean radius of the centrifugal chamber in the cylindrical section.

In a further particularly preferred embodiment variant of the invention, it is provided that during operation in the region of the outlet nozzle a counter pressure acts such that a further portion Su″ of the suspension Su flows further downstream into the second smaller-diameter feed pipe section close to the axis of rotation D of the feed pipe. In this way, the suspension Su is already divided in the feed pipe into a proportion Su′ with a higher solids content and a proportion Su″ with a lower solids content compared to the solids content of the suspension Su to be clarified.

It is also provided in a further particularly preferred embodiment variant of the invention that the second means, by which the other portion Su″ of the suspension Su can be introduced into the centrifugal chamber in the radial direction, are designed as at least one second feed sleeve extending radially from the feed pipe into the centrifugal chamber. In this way, a gentle introduction of the other portion Su″ of the suspension Su into the centrifugal chamber is made possible by structurally simple means, which are just as easy to implement in terms of production technology.

Furthermore, in a further particularly preferred embodiment variant of the invention, it is provided that the respective second feed sleeve forms an outlet nozzle through which the other portion Su″ of the suspension Su is directed into the centrifugal chamber at a radius R2. A second radius R2, at which the respective second feed sleeve opens into the centrifugal chamber, is selected such that the discharge of the other portion Su″ of the suspension Su into the corresponding layer in the centrifugal chamber, which essentially consists of liquid phase, takes place advantageously without major turbulence interfering with other phase occurring during the introduction.

The second radius can be smaller than the mean radius in the cylindrical section of the centrifugal chamber. The second radius is therefore preferably smaller than the first radius. The difference between the two radii, at which the respective feed sleeves open into the centrifugal chamber, enables the discharge of particles or heavy/light liquid phases FI into the corresponding layer in the centrifugal chamber without creating major turbulence during the introduction, which interferes with other phases.

In a further particularly preferred embodiment variant of the invention, it is provided that the introduction of the first portion Su′ of the suspension Su by the first means takes place closer to the liquid discharge than the introduction of the remaining portion Su″ of the suspension Su by the second means.

It may be provided, for example, that the introduction of the portion Su′ into the centrifugal chamber takes place so close to the bowl cover that the solid phase Fe contained therein has to travel a long distance in the centrifugal chamber until it leaves the bowl at the solids discharge. As a result, the solid phase of the suspension Su′ introduced through the first feed sleeve has a maximum dwell time in the centrifugal chamber before it is discharged from the bowl. This advantageously results in an optimized degree of separation.

In a further particularly preferred embodiment of the invention, it may be provided that the introduction of the other portion Su″ of the suspension Su into the centrifugal chamber takes place relatively close to the conical section of the bowl, so that the liquid phase FI contained therein has to travel a relatively long distance in the centrifugal chamber until it finally leaves the bowl at the liquid outlet. As a result, the liquid phase of the suspension Su″ introduced through the second feed sleeve has a maximum dwell time in the centrifugal chamber before it is discharged from the bowl. This advantageously results in an optimized degree of separation.

The problem is also solved by the following method: A method for centrifugal clarification of a suspension Su, so that a solid phase Fe and at least one liquid phase FI are formed, in a provided solid bowl screw centrifuge according to one of the preceding claims, wherein
a. the suspension Su is fed through a feed pipe, which rotates during operation of the solid bowl screw centrifuge, into the centrifugal chamber of the solid bowl screw centrifuge, wherein the inner diameter of the feed pipe initially increases in the axial direction towards the conical section of the screw in the direction of flow in such a way that a first feed pipe section is formed in which centrifugal pre-separation of a part of the solid phase Fe from the suspension Su takes place, wherein first means are present through which a first portion Su′ of the suspension with a higher solid content compared with the suspension Su is introduced into the centrifugal chamber in the radial direction, and
b. wherein the first feed pipe section is further adjoined axially in the direction of flow by a second feed pipe section, through which the remaining second portion Su″ of the suspension Su with a lower solids content compared with Su close to the axis of rotation of the feed pipe, which is not diverted by the first means, is guided axially further through the feed pipe, wherein second means are provided, through which the remaining second portion Su″ of the suspension is introduced in the radial direction into the centrifugal chamber, and
c. whereupon further clarification of the two suspension portions takes place in the centrifugal chamber.

Further advantageous designs of the invention can be found in the sub-claims.

### BRIEF DESCRIPTION OF THE DRAWING FIGURES

In the following, the invention is described in more detail with reference to the drawing by means of exemplary embodiments. Features described in connection with these exemplary embodiments can also be used in other—not shown—exemplary embodiments of the invention and can therefore also be used as features for claims, wherein:

FIG. 1: shows a schematic sectional view of a rotor of a solid bowl screw centrifuge according to the invention;

FIG. 2: shows an enlargement of a section of FIG. 1; and

FIG. 3: shows a schematic sectional view of a solid bowl screw centrifuge according to the prior art.

### DETAILED DESCRIPTION

In the following description of the figures, one or more exemplary embodiments of a solid bowl screw centrifuge are described. Individual and also several of the individual features of these exemplary embodiments can also be used in other exemplary embodiments not shown, which are to be included in the claims.

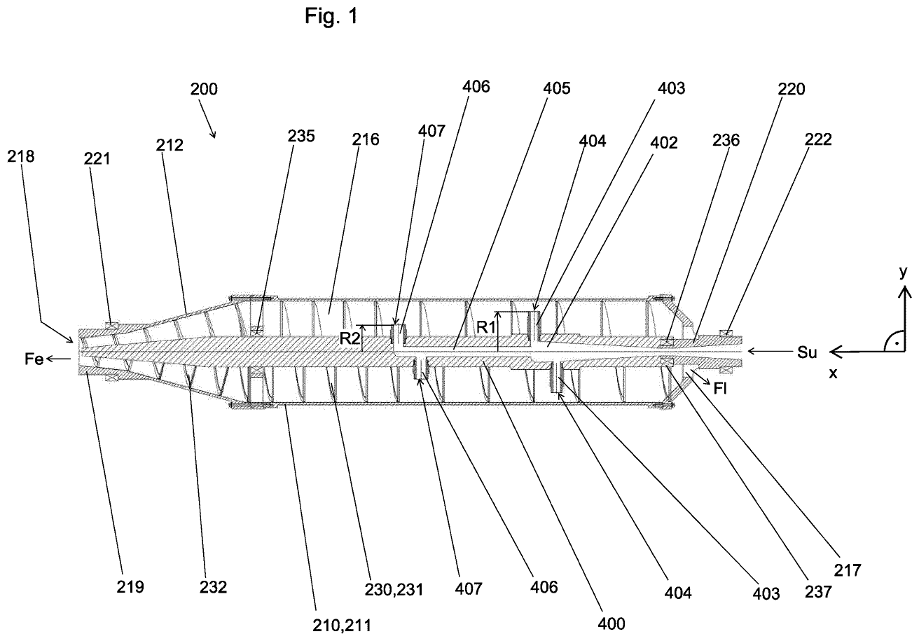

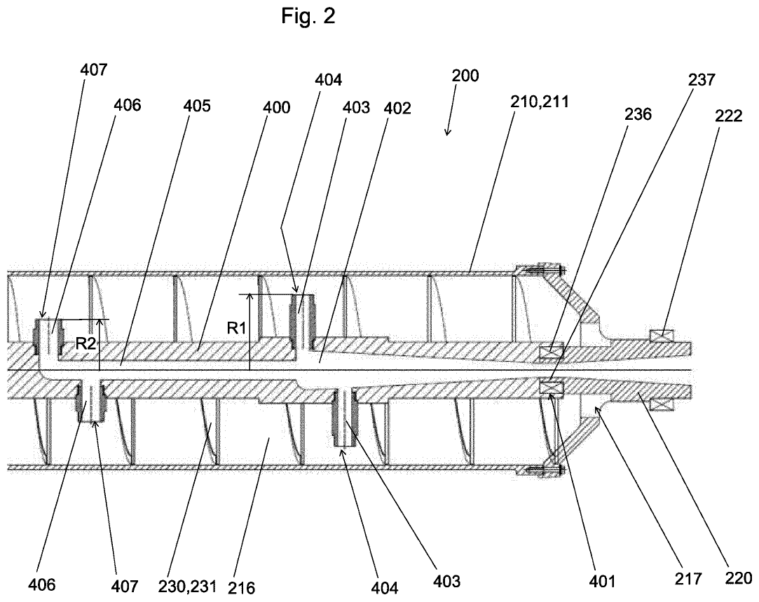

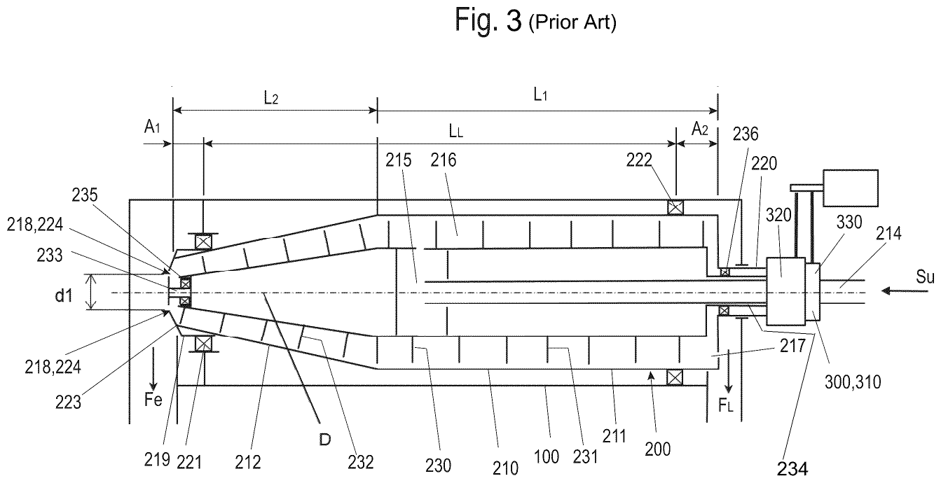

First of all, the solid bowl screw centrifuge of FIG. 3 of the prior art is described, which is modified and further developed in accordance with the invention in FIGS. 1 and 2.

FIG. 3 shows a solid bowl screw centrifuge for processing a suspension Su in a centrifugal field with a frame 100—which cannot rotate or does not rotate during operation and which can be designed as a type of housing—and a rotor 200 which can rotate or rotates during operation. The rotor 200 has a rotatable bowl 210 with a horizontal axis of rotation D. However, the axis of rotation D can also be oriented differently, in particular vertically, in space. The rotor 200 also includes a screw 230 arranged in the bowl 210, the axis of rotation of which coincides with the axis of rotation D of the bowl 210.

The bowl 210 has a cylindrical section 211 with a length L1 and an axially adjoining conical section 212 with a length L2. The cylindrical section 211 is closed here by a substantially radially extending bowl cover 213. In the conical section 212 with the length L2, the bowl 210 is preferably conical on the inside and outside (in relation to the bowl shell).

The screw 230 also has a cylindrical section 231 and an axially adjoining conical section 232. It is arranged inside the bowl 210. During operation, the screw 230 can be rotated at a differential speed to the bowl 210.

A feed pipe 214, which is arranged here concentrically to the axis of rotation D and is preferably stationary during operation of the solid bowl screw centrifuge, projects into the bowl 210 and opens into a distribution chamber 215 through which a suspension to be processed can be fed here radially into a centrifugal chamber 216 of the bowl 210. The feed pipe 214 can either be guided into the bowl 210 from the side of the cylindrical bowl section 211 or it can be guided into the bowl 210 from the side of the conical bowl section 212.

The distribution chamber 215 is arranged here in the bowl 210 in the cylindrical bowl section 210 and is positioned in the axial direction shortly before the end of the cylindrical bowl section 210, which is adjoined by the conical bowl section 212.

One or more liquid outlets 217 may be formed in or on the bowl cover 213. These can be formed in various ways, for example as openings in the bowl cover 213, which form the function of a type of overflow weir, or in other ways, for example as a paring disk.

At least one solids discharge 218 is formed in the conical section 212, in particular in the end region of the conical section 212.

The bowl 210 is designed as a solid-wall bowl. In the rotating bowl 210, at least one liquid phase FI is clarified from solids Fe. The at least one liquid phase FI emerges from the liquid outlet 217 at the bowl cover 213. The solids Fe, on the other hand, are transported by the screw 230 in the direction of the solids discharge 218, where they are ejected from the bowl 210. It is also conceivable that, in addition, separation into two liquid phases also takes place if corresponding outlets are provided for these liquid phases.

A first bowl shaft section 220, which is non-rotatably connected to the bowl 210, can be axially connected to the bowl cover 213 or to the actual bowl 210, and a second bowl shaft section 219, which is also non-rotatably connected to the bowl 210, can be axially connected to the conical bowl section 212.

The cylindrical section 231 of the screw 230 is axially connected to a first screw shaft section 234, which can be non-rotatably connected to the screw 230. The conical section 232 is mounted on a bearing 235. This bearing 235 can be mounted on a second screw shaft section 233.

A drive device, which may have one or two motors, is used to drive the rotor 200. At least one gear 310 can be connected downstream of the drive device 300, on which two pulleys 320, 330 are schematically shown here, which indicates that the gear 310 can have at least two interfaces for feeding a respective torque of the motor or motors into the gear 310 in order to drive the bowl 210 and the screw 230. Alternatively (not shown here), the rotor 200 may be driven by other means.

According to FIG. 3, the gear 310 rotates the bowl 210 on the one hand and the screw 230 on the other. For this purpose, the gear 310 can have two output shafts. The first output shaft can be coupled non-rotatably to the first bowl shaft section 220 or coupled directly to the bowl 210. The second output shaft, on the other hand, can be coupled directly or indirectly to the first screw shaft section 234 in a rotationally fixed manner or directly to the screw 230.

The bowl 210 can be rotatably mounted with two bowl bearings 221, 222 arranged axially offset in the direction of the axis of rotation. In this respect, the term “bearing” is not to be understood too narrowly. Each of the bowl bearings 221, 222 can each consist of one or more individual bearings, which are then arranged axially directly next to one another, so that they can each be regarded functionally as a single bearing.

The bowl bearings 221, 222 can advantageously be arranged between the bowl 210 and the frame 100 or one or more elements connected to the frame so that the bowl 210 can be rotated relative to the frame 100. This also applies to all other variants shown. In this case, the bowl bearings 221, 222 are preferably arranged radially between the bowl 210 and the frame 100 or one or more element(s) connected to the frame.

The screw bearings 235, 236, on the other hand, can be arranged radially between the screw 230 and the bowl 210, so that the screw 230 can be rotatable relative to the bowl 210.

In a possible embodiment variant (not shown), one of the screw bearings 235 in the area of the solids discharge 218 can be omitted. This can be provided, for example, if the decanter is arranged vertically.

One or even both bowl bearings 221, 222 may be arranged within the axial region located between the solids discharge 218 and the liquid outlet 217 of the bowl 210 or directly adjacent to a region of the liquid outlet 217 and/or a solids discharge 218 of the bowl 210. The bowl bearings 221, 222 are then positioned radially on the outside of the bowl 210 or radially or axially on the outside of the bowl cover 213.

If one of the bowl bearings 221, 222 is arranged within the axial region laying between the solids discharge 218 and the liquid outlet 217 of the bowl 210, the other of these bearings—the other of the bowl bearings 221, 222—can be arranged outside this axial region.

It may be provided that the bowl bearings 221, 222 are spaced at a distance LL from the bearing of the bowl 210 in the housing 100, the distance LL between the bowl bearings 210 being smaller than the axial length LT of the bowl.

The solids discharge 218 can be designed such that the openings of the solids discharge 218 are oriented radially or substantially in the radial direction of the bowl 210.

The solids discharge 218 in the solid bowl screw centrifuge according to the prior art in FIG. 3 is designed such that the openings 224 of the solids discharge 218 are aligned axially or substantially in the axial direction of the bowl 210. They are also preferably located within the smallest diameter of the conical area 212 of the bowl 210.

In operation, solids in the rotating bowl 210 are first conveyed from a suspension Su rotating radially outside in the bowl 210 out of the cylindrical region into the conical region 212 of the bowl 210 and from there further conveyed or pushed radially inwards to the solids discharge 218.

For this purpose, a solids discharge bowl cover 223 adjoins the conical section of the bowl 210 in the axial direction, which axially closes off the conical section 212 of the bowl 210. The solids discharge bowl cover 223 can be conical in its entirety or in sections. The solids discharge 218 can be designed in such a way or in this case that the openings 224 of the solids discharge 218 are aligned axially or substantially in the axial direction of the bowl 210.

The solids discharge bowl cover 223 can have one or more, for example four, openings 224, which form the solids discharge 218. These can be formed as window-like, circumferentially closed openings in the conical section of the solids discharge bowl cover 223.

This design according to the prior art has proven itself in practice, but it is to be optimized with regard to its clarification properties, for example in the event that a suspension of solids to which a flocculant has been added is to be clarified.

The flocculant is used to form larger microflocs or even larger macroflocs from the solids content of the suspension Su, which can be easily separated from the suspension Su by the clarification or separation process in the solid bowl screw centrifuge. The problems occur when there is a turbulent flow in the distribution chamber of the solid bowl screw centrifuge and the microflocs or macroflocs are destroyed by the occurrence of corresponding shear forces in the suspension Su.

FIGS. 1 and 2 each show the rotor 200 of an exemplary solid bowl screw centrifuge according to the invention. Apart from the design of the feed pipe, this can be constructed in the same way as in FIG. 3, but can also have a different type of bearing or a different type of drive.

The rotor 200 of the solid bowl screw centrifuge also has a rotatable bowl 210 with a horizontal axis of rotation D. However, the axis of rotation D can also be oriented differently, in particular vertically, in space. The rotor 200 also includes a screw 230 arranged in the bowl 210, the axis of rotation of which coincides with the axis of rotation D of the bowl 210.

The bowl 210 also has a cylindrical section 211 with a length L1 and an axially adjoining conical section 212 with a length L2. The cylindrical section 211 is closed here by a bowl cover 213. In the conical section 212 with the length L2, the bowl 210 is preferably conical on the inside and outside (in relation to the bowl shell).

The screw 230 also has a cylindrical section 231 and an axially adjoining conical section 232. It is arranged inside the bowl 210. During operation, the screw 230 can be rotated at a differential speed to the bowl 210.

One or more liquid outlets 217 may also be formed in or on the bowl cover 213. These can be formed in various ways, for example as openings in the bowl cover 213, which form the function of a type of overflow weir, or in another way, for example as a paring disk.

At least one solids discharge 218 is also formed at the end of the conical section 212 of the bowl 210.

The bowl 210 is also designed as a solid-wall bowl. In the rotating bowl 210, at least one liquid phase FI is clarified from solids Fe. The at least one liquid phase FI emerges from the liquid outlet 217 at the bowl cover 213. The solid phase Fe, on the other hand, is transported by the screw 230 in the direction of the solids discharge 218, where it is ejected from the bowl 210.

A feed pipe 400, which is arranged here concentrically to the axis of rotation D and can rotate during operation of the solid bowl screw centrifuge or rotates with the bowl 210 or the screw, projects into the bowl 210, through which a suspension or the suspension Su to be processed can be fed into the centrifugal chamber 216 of the bowl 210. The feed pipe 400 can either be guided into the bowl 210 from the side of the cylindrical bowl section 211 or it can be guided into the bowl 210 from the side of the conical bowl section 212.

The feed pipe 400 can also take over the function of the screw shaft or form it. It is rotatably mounted in the bowl 210. The screw 230 can be assembled from the screw shaft with the feed pipe 400 and a screw helix, e.g., welded together. Alternatively, a one-piece screw 230 with the screw shaft and the feed pipe 400 located in the screw shaft is also possible. In this respect, the feed pipe 400 rotates at the screw speed during operation of the solid bowl screw centrifuge.

The screw 230, or more precisely the screw shaft, can in turn be supported by a first screw bearing 235 and a second screw bearing 236. The first screw bearing 235 and the second screw bearing 236 are each arranged here radially between the screw 230 and the bowl 210, so that the screw 230 is rotatable relative to the bowl 210. The first screw bearing 235 and the second screw bearing 236 are each designed here as rolling bearings. The respective rolling bearing can be designed as a single-row or multi-row bearing. Combinations of several rolling bearings per bearing position are also possible.

The first screw bearing 235 is positioned here in the axial direction shortly before the end of the cylindrical bowl section 210, which is adjoined by the conical bowl section 212. In a possible embodiment variant (not shown), one of the screw bearings 235 can be omitted in the area of the solids discharge 218. This can be provided, for example, if the decanter is arranged vertically.

The second screw bearing 236 is arranged here in the axial direction in the region of the bowl cover 213 between the bowl shaft section 234, which here projects axially into the bowl 210 in the direction of the conical bowl section 212, and the screw shaft with the feed pipe 400.

An inner ring of the second screw bearing 236 can be placed on a shoulder 237 of the bowl cover 213, while an outer ring of the second screw bearing 236 is inserted into a bore 401 of the screw shaft section 234 arranged coaxially to the axis of rotation D of the feed pipe 400.

The inner diameter of the feed tube 400 is not constant. Rather, the inner diameter initially increases in the axial direction from the inlet to the conical section 232 of the screw 230 in a first section, in particular continuously. In this way, a first feed pipe section 402 is formed with increasing diameter. This first feed pipe section 402 here forms an inner cone. It is also possible that the first feed pipe section 402 has an inner paraboloid or another geometry with an inner diameter that increases continuously in the axial direction towards the conical section 232 of the screw 230.

This expansion, in particular the continuous expansion of the feed pipe 400 in the area of the first feed pipe section 402, creates a rotating annular space in which the centrifugal forces can already cause an initial centrifugal separation, a kind of “pre-clarification”. As a result, heavier portions of the fed suspension Su already collect on the inside on the outer wall of the conical first feed pipe section 402 due to the forces acting on the suspension Su in the rotating feed pipe 400. In this way, a certain pre-separation/pre-clarification of the solid phase Fe advantageously already takes place in the feed pipe 400 and a partial flow Su′ with a higher solids content compared to the solids content of the suspension Su and a partial flow Su″ with a lower solids content are formed from the fed suspension Su.

The conical feed pipe section can-preferably on its inner circumference—be provided with one or more entrainment elements, such as ribs, so that the incoming suspension can be accelerated more easily to the speed of the feed pipe. The ribs can, for example, extend essentially radially inwards from the inner diameter of the conical feed pipe section and also run axially, for example.

First means 403 are provided in the region of the largest diameter of the first feed pipe section 402, through which the partial flow Su′ can be introduced into the centrifugal chamber 216 in the radial direction. The first means 403 is designed here as at least one first feed sleeve 403. The respective first feed sleeve 403 extends substantially in the radial direction from the region of the largest diameter of the first feed pipe section 402 into the centrifugal chamber 216 and can form an outlet nozzle 404. Through the respective first feed sleeve 403, the partial flow Su′ is directed into the centrifugal chamber 216 at a suitable first radius R1. The outlet nozzle 404 can preferably have a smaller but also the same diameter as the rest of the feed sleeve 403.

Due to the “early” introduction of the partial stream Su′ into the centrifugal chamber 216 in the axial direction, the solid phase Fe contained in this partial stream has to cover a relatively long axial path to the solid discharge 218, whereby good further separation is achieved. The term “early” means that the introduction of the pre-separated solid phase Fe into the centrifugal chamber 216 takes place here axially in direction X with respect to the coordinate system in FIG. 1 relatively close to the bowl cover 213, so that the solid phase Fe has to travel a relatively long distance in the centrifugal chamber 216 until it finally leaves the bowl 210 at the solid discharge 218 as solid phase Fe. By suitably dimensioning the diameter of the outlet nozzle 404, sufficient counterpressure is generated such that the partial flow Su″ of the suspension Su can flow or flow radially further inwards or close to the axis of rotation D of the feed pipe 400 further downstream into a second feed pipe section 405 viewed axially in the direction X, wherein second means 406 are provided through which the remaining portion Su″ of the suspension Su can be introduced in the radial direction into the centrifugal chamber 216.

The second feed pipe section 405 does not have a continuously increasing diameter here, but can have a constant diameter. This is smaller than the largest diameter of the first feed pipe section. Alternatively, the second feed pipe section 405 can also be designed with a continuously increasing diameter. It is also possible for the feed pipe 400 to have more than two feed pipe sections 402, 405, which are fluidically connected to one another.

The second means 406, through which the other portion Su″ of the suspension Su can be introduced in a radial direction into the centrifugal chamber 216, is designed here as at least one second feed sleeve 406, which extends from the second feed pipe section substantially in a radial direction into the centrifugal chamber 216. It can form an outlet nozzle 407. Through the respective second feed sleeve 406, the other portion Su″ of the suspension Su is directed into the centrifugal chamber 216 at a suitable second radius R2.

This second portion Su″ of the suspension Su may contain some, in particular relatively light, solid particles and essentially the liquid phase FI.

The radius R2, via which the other portion Su″ of the suspension Su is introduced into the centrifugal chamber 216, is preferably smaller than the radius R1, via which the first portion Su′ of the suspension Su is introduced into the centrifugal chamber 216.

Due to the axially relatively “late” introduction of the other second portion Su″ of the suspension Su into the centrifugal chamber 216, the liquid phase FI contained therein has to cover a relatively long distance “back” to the liquid outlet 217, which helps to optimize the clarification process.

The term “late” means that the introduction of the other portion Su″ of the suspension Su″ into the centrifugal chamber 216 takes place here relatively close to the conical section 212 of the bowl 210, so that the liquid phase of the suspension Su″ introduced through the second feed sleeve has to travel a relatively long distance in the centrifugal chamber 216 until it finally leaves the bowl 210 at the liquid outlet 217 as liquid phase FI.

The embodiment of the feed pipe 400 according to the invention results in a number of advantages:

In the area of the increasing radius, pre-separation of the solid phase Fe can already take place in the feed pipe due to the centrifugal forces, but with a relatively low effect of shear forces. This is because the centrifugal forces are still relatively small close to the axis of rotation in the first feed pipe section compared to the shear forces occurring in the centrifugal chamber.

In particular, a larger proportion of the solid phase Fe can already be discharged from the first feed pipe section 402 into the centrifugal chamber 216 with the first proportion Su′ of the suspension Su. Since the respective feed sleeve 403 forms an outlet nozzle 404 at which a counter pressure is generated during operation, another portion Su″ of the suspension Su will continue to flow into the second feed pipe section 402. The inlet to the second feed pipe section 402 has a smaller diameter than the largest diameter of the first feed pipe section, from which a first portion of the suspension is fed into the bowl.

The respective radius R1, R2, on which the respective feed sleeves 403, 406 as first and second feed means for the respective suspension Su′ and Su″ open into the centrifugal chamber 216, enables the discharge of particles or heavy/light liquid phases FI into the corresponding layer in the centrifugal chamber 216 without causing major turbulence during the introduction, which interferes with other phases.

Each phase of the suspension Su is given an optimized dwell time in the centrifugal chamber 216 before it is discharged from the bowl 210.

Further feed pipe sections or pre-separation stages can be provided in the feed pipe 400 and thus added up to a final stage in which the remaining product (mainly the remaining liquid phase FI) is discharged into the centrifugal chamber 216 through feed sleeves without nozzles and thus without counter pressure.

### LIST OF REFERENCE SIGNS

200 Rotor
210 Bowl
211 Cylindrical section
212 Conical section
213 Bowl cover
216 Centrifugal chamber
217 Liquid outlet
218 Solids discharge
219 Bowl shaft section
220 Bowl shaft section
221 Bowl bearing
222 Bowl bearing
223 Solids discharge bowl cover
224 Opening
230 Screw
231 Cylindrical section
232 Conical section
233 Screw shaft section
234 Screw shaft section
235 Screw bearing
236 Screw bearing
237 Shoulder
300 Drive device
310 Gear
320 Pulley
330 Pulley
400 Feed pipe
401 Shoulder
402 First feed pipe section
403 First feed sleeve
404 Outlet nozzle
405 Second feed pipe section
406 Second feed sleeve
407 Outlet nozzle
D Axis of rotation
L1 Length
L2 Length
LL Distance between bowl bearings
Su Suspension
Su′ Partial flow of the suspension
Su″ Partial flow of the suspension
Fe Solids
FI Liquid phase
R1 Radius
R2 Radius

1-15. (canceled)

16. A solid bowl screw centrifuge configured to clarify a suspension in a centrifugal field from a solid phase, the solid bowl centrifuge comprising:
a housing;
a rotor rotatably mounted in the housing;
a rotatable bowl with an axis of rotation, wherein the rotatable bowl has a cylindrical section and a conical section;
a feed pipe projecting into the rotatable bowl, arranged concentrically to an axis of rotation, and through which the suspension to be processed is feedable into a centrifugal chamber of the rotatable bowl;
at least one liquid outlet arranged in the cylindrical portion of the rotatable bowl;
at least one solids discharge arranged in the conical section of the rotatable bowl; and
a screw arranged in the rotatable bowl and configured to rotate relative to the rotatable bowl at a differential speed,
wherein the feed pipe is configured to rotate with the rotor during operation of the solid bowl screw centrifuge,
wherein an inner diameter of the feed pipe initially increases in an axial direction towards the conical section of the screw in a direction of flow such that a first feed pipe section is formed in which part of the solid phase is centrifugally pre-separated from the suspension, wherein the first feed pipe section includes first means through which a first portion with a higher solids content compared with the suspension is introducible into the centrifugal chamber in a radial direction, and
wherein the first feed pipe section is adjoined axially in the direction of flow by a second feed pipe section through which a remaining second portion of the suspension with a lower solids content compared with the suspension Su, which is not discharged by the first means, is guided axially further through the feed pipe, wherein the second feed pipe section includes second means through which the remaining second portion of the suspension is introducible into the centrifugal chamber in the radial direction.

17. The solid bowl screw centrifuge of claim 16, wherein the inner diameter of the feed pipe in the first feed pipe section increases continuously over an axial length of the first feed pipe section.

18. The solid bowl screw centrifuge of claim 16, wherein the first feed pipe section forms an inner cone.

19. The solid bowl screw centrifuge of claim 16, wherein the first feed pipe section forms an inner paraboloid.

20. The solid bowl screw centrifuge of claim 16, wherein the first means is at least one first feed sleeve extending radially from the first feed pipe section into the centrifugal chamber.

21. The solid bowl screw centrifuge of claim 20, wherein the at least one first feed sleeve forms an outlet nozzle through which the first portion of the suspension is directed into the centrifugal chamber on a first radius.

22. The solid bowl screw centrifuge of claim 21, wherein during operation of the solid bowl screw centrifuge the outlet nozzle generates such a counterpressure that the second remaining portion of the suspension flows further downstream into the second feed pipe section close to the axis of rotation D of the feed pipe.

23. The solid bowl screw centrifuge of claim 16, wherein the second feed pipe section has a diameter that is smaller than a largest diameter of the first feed pipe section.

24. The solid bowl screw centrifuge of claim 21, wherein the second means is at least one second feed sleeve extending radially into the centrifugal chamber.

25. The solid bowl screw centrifuge of claim 24, wherein the first or the second feed sleeve forms an outlet nozzle.

26. The solid bowl screw centrifuge of claim 25, wherein a radius, via which the other portion of the suspension is introduced into the centrifugal chamber, is smaller than the first radius.

27. The solid bowl screw centrifuge of claim 16, wherein the first means are arranged closer to a bowl cover than the second means.

28. The solid bowl screw centrifuge of claim 16, wherein the introduction of the other portion of the suspension into the centrifugal chamber is achieved by the second means closer to the conical section of the rotatable bowl than the introduction of the first portion of the suspension Su by the first means.

29. The solid bowl screw centrifuge of claim 16, wherein the conical feed pipe section includes one or more entrainment elements configured to support acceleration of the suspension to a rotational speed of the feed pipe.

30. The solid bowl screw centrifuge of claim 29, wherein the one or more entrainment elements are one or more ribs.
